(19) United States
(12) Patent Application Publication
(10) Pub. No.: US 2005/0285318 A1
(43) Pub. Date: Dec. 29, 2005

(54) Hydro-mount

(76) Inventor: Gerold Winkler, Birkenau (DE)

Correspondence Address: HARNESS, DICKEY & PIERCE, P.L.C., P.O. BOX 828, BLOOMFIELD HILLS, MI, 48303, US

(21) Appl. No.: 11/006,511

(22) Filed: Dec. 7, 2004

(30) Foreign Application Priority Data
Dec. 17, 2003 (DE) 103 59 457.4-12

(51) Int. Cl. F16F 13/00

(52) U.S. Cl. 267/140.13; 267/140.11

(57) ABSTRACT

Hydro-mount comprising a support bearing and an end bearing linked to each other by a bearing spring made of an elastic material and which enclose a working chamber and a compensation chamber, both filled with a damping liquid, the working chamber and compensation chamber being separated from one another on their sides that face each other by a common dividing wall and being connected to each other in flow-conveying manner by a first damping channel, the first damping channel (8) being associated with a second damping channel (9) that can be switched to function in parallel therewith.

### TECHNICAL FIELD

The invention relates to a hydro-mount comprising a support bearing and an end bearing which are connected to each other by means of a bearing spring made of an elastic material and which enclose a working chamber and a compensation chamber filled with damping liquid, the working chamber and compensation chamber on the sides facing each other being separated by a common dividing wall and being connected to each other through a first damping channel in liquid-conveying fashion.

### PRIOR ART

Such hydro-mounts are generally known and are used, for example, between the internal combustion engine and the chassis of a motor vehicle. The first damping channel can be designed so as to be switchable. In this case, the first damping channel is opened to dampen the vibrations of the idling internal combustion engine. If, on the other hand, the internal combustion engine is no longer idling, the first damping channel is closed, and the vibration damping/isolation is also carried out in a manner that in and of itself is known. The vibrations are dampened by the damping liquid being displaced back and forth through a damping channel between the working chamber and the compensation chamber (damping of low-frequency, high-amplitude vibrations such as those generated by the motor vehicle running over the edge of a curb). The isolation of higher-frequency, low-amplitude vibrations, generated by the engine creating inherent movements as a result of the combustion and by the non-uniformity of the crankshaft drive, is effected by a membrane that consists of elastic material and is made to move back and forth between stops, for example the stops of a jet cage, out-of-phase, but ideally in-phase with the vibrations introduced.

### PRESENTATION OF THE INVENTION

The object of the invention is to further develop a hydro-mount of the prior art in a manner such that vibrations of a higher order, particularly of the fourth order (four cylinders) or sixth order (six cylinders) can be better dampened during idling. The purpose is to reduce the dynamic spring rate in the range of frequencies of the fourth or sixth order.

According to the invention, this objective is reached through the features of claim 1. Advantageous other embodiments are covered in the subclaims.

To reach the said objective, there is provided a second damping channel that is associated with the first damping channel so that they can be switched to function in parallel. The said damping channels are always to be viewed as a damping system. The two damping channels are adjusted to different frequencies so that inertial forces of the second and fourth order (in case of four cylinders) or third and sixth order (in case of six cylinders) are dampened.

By vibration order is meant a vibration excitation arising from a plurality of excitations that result from inertial forces and/or combustion processes during one rotation of the crankshaft.

The advantageous effect brought about by the second damping channel, which is switched to function in parallel with the first damping channel, lies in that as a result of the parallel switching, the hydro-mount of the invention can dampen simultaneously vibrations of the second and fourth order or simultaneously vibrations of the third and sixth order.

In general, the first and/or second damping channel can be designed to be switchable. In this context, switchable means that the damping channels can be brought into an open or closed position, depending on a particular operating condition of the supported assembly, for example an internal combustion engine. As a result, the function of the hydro-mount can be adapted in highly variable manner to the operating condition of the supported assembly. For the example of an internal combustion engine, this means the following.

For example, if a six-cylinder in-line engine is running at a certain rotational speed, then in the third order a vibration excitation is generated three times per rotation and in the sixth order six times. The excitation frequencies thus generated lie so far apart that a single vibrating system, for example known from the prior art, cannot take over the damping for both excitations. In designing the system, it is therefore necessary to choose one of the two excitation frequencies.

By contrast, the design according to the invention involving two damping channels/damping systems makes it possible to dampen both frequencies at the same time and thus to reduce oscillation-induced vibrations.

If the spring-fluid mass systems of the damping channels are allowed to dampen both oscillations as a result of resonance, then it will always be the non-damping channel that takes up fluid with its membrane and weakens the performance of the working damping system. The switching makes it possible to eliminate this undesirable yielding in the bearing. As a result, the efficacy of the damping system that is working at the time is increased.

Switching is designed essentially as a function of the dominant order which depends on the speed of rotation. For example, the efficacy of the damping systems increases in the following order: two passive systems produce the least efficacious damping. If one system is rendered switchable, then the damping at the frequency of the other system is increased.

Within the framework of the present invention, it is, for example, possible to make the first damping channel switchable and the second one non-switchable, namely passive. The advantage in this case is that such a hydro-mount represents an excellent compromise between a comparatively simple, inexpensive construction, on the one hand, and very good use properties, on the other. Most applications do not require a second damping switchable channel in addition to the first switchable damping channel.

In the afore-described hydro-mount, it is possible to have the second damping channel subdivided into two partial damping channels by a first membrane made of an elastically yielding material, to have the membrane tightly separate the partial damping channels from one another, to have the first partial damping channel axially facing the working chamber filled with damping liquid and the second damping channel with air, and to have the second partial damping channel connected to the atmosphere through a flow-conveying air vent. By the fact that the second partial damping channel is filled with air and that air is a compressible medium, the use properties of the hydro-mount in terms of damping of vibrations of the fourth and sixth order are particularly good. The use properties can be improved further by always having atmospheric pressure prevail within the second partial damping channel, for example as a result of the fact that the second partial damping channel is connected with the atmosphere through an air vent. Excitation by the engine to a higher than damping frequency will result in undesirable dynamic hardening of the hydro-mount. In this case, the damping system will, as a result of mass effects and phase position, enhance the excitation. To prevent this, it is advisable to change the pressure within the air chamber by opening or closing it so that the damping system, because of the difference in spring rates between the membrane and the air chamber, will leave the critical frequency range.

In general, however, it is also possible to design the two damping channels to be non-switchable, namely passive. Such a very simple configuration of the hydro-mount is reasonable particularly when the excitation is comparatively low and an inexpensive design is required.

Preferably, the first membrane is in the form of a bellows. The mechanical load on the first membrane during proper use of the hydro-mount is thus reduced to a minimum. Use life-reducing tensile/shearing stresses, to which the elastomeric materials that preferably constitute the membrane react sensitively, are thus prevented. A back-and-forth displacement of the membrane in the direction of the vibrations introduced results exclusively in a flexing movement of the elastomeric material in the region of the bellows. For this reason, the hydro-mount of the invention has constantly good use properties during its very long use life.

The air vent can be located in the support bearing. The fabrication of such an air vent is very simple and is advantageous particularly when the second damping channel is also disposed in the support bearing and extends essentially in the direction of the vibrations introduced. The second damping channel and the air vent are then disposed in fixed relationship to one another which simplifies the adjustment of the hydro-mount to the frequencies that are to be dampened.

For fabrication-related reasons, the first and second damping channel are preferably coaxial and disposed near each other at an axial distance. When both damping channels are switched to function in parallel then, as a result of the coaxial arrangement of the damping channels, the volumes enclosed by each of the two damping channels can vibrate back and forth in phase with the vibrations introduced and with the least possible flow resistance. The displacement of the volumes so as to offer the least possible flow resistance is necessary to prevent undesirable dynamic hardening of the bearing in this operating condition.

From a flow standpoint, the coaxial arrangement of two damping channels disposed near each other at an axial distance is particularly advantageous for achieving a decrease in dynamic spring rate in the range of vibrations of the fourth and sixth order.

To attain these very favorable flow properties that are highly advantageous for a proper functioning of the hydro-mount, it is advantageous to dispose the first damping channel in the center of the dividing wall. The support bearing, the second damping channel that is disposed in the support bearing and the first damping channel are aligned by the coaxial arrangement. As a result, the damping of the vibrations of the fourth and sixth order is particularly efficient.

The first and second damping channel can each be disposed in the region of the mutually axially facing front boundaries of the working chamber, with each channel opening into the working chamber and the second damping channel being open in the direction of the working chamber. Such a configuration is advantageous when the vibrations to be dampened are introduced in the axial direction.

The volume of the first damping channel is preferably greater than that of the second damping channel. This ensures that at the idling speed of the internal combustion engine, with both the first and the second damping channel open, the comparatively smaller volume of the second damping channel can, with only low flow resistance, also vibrate through the orifice of the first damping channel.

If, conversely, the volume of the second damping channel were larger than that of the first damping channel, then with both the first and the second damping channel open, the comparatively larger liquid volume of the second damping channel would have to squeeze through a comparatively small first damping channel, which would cause undesirably high friction and an undesirable effect on damping. The use properties of the hydro-mount would thereby be adversely affected.

The dividing wall is preferably formed by a jet cage comprising an upper and a lower jet plate, with a second elastic membrane is disposed between the jet plates in a manner permitting vibration. The second elastic membrane disposed within the jet cage is intended to isolate high-frequency, low-amplitude vibrations. Such vibrations are set off, for example, by the fact that the engine is running at a high rotational speed. The low-amplitude, high-frequency vibrations pass into the hydro-mount and are isolated by a movable second membrane.

Moreover, the jet cage can enclose an attenuation channel that connects the working and compensation chambers in flow-conveying manner. The attenuation channel preferably extends on the outer periphery along the jet cage. As a result of the relatively great length and the large liquid volume enclosed by the long attenuation channel, the low-frequency, high-amplitude vibrations, set off, for example, by the vehicle running over the edge of a curb, can be effectively attenuated.

A plug made of a sealing material may be used to close off the first damping channel. By use of a plug made of a sealing material, the damping channel can always be reliably closed off during a long use period.

The plug can be made integral with and of the same material as the sealing membrane that provides a boundary for the compensation chamber on the side facing away from the dividing wall. The sealing membrane is preferably in the form of a bellows and is capable of taking up in essentially pressure-less manner the damping liquid which during proper use of the hydro-mount is forced from the working chamber into the compensation chamber.

### BRIEF DESCRIPTION OF THE DRAWINGS

In the following, the hydro-mount of the invention will be explained in greater detail by reference to FIGS. 1 to 4. These figures are schematic representations of the following.

FIG. 1 shows an exemplary embodiment of a hydro-mount of the invention in longitudinal cross-section,

FIG. 2 shows a support bearing, an end bearing and a bearing spring linking the support bearing and the end bearing, in a configuration differing from that of FIG. 1,

FIG. 3 shows the upper part of the hydro-mount of FIG. 2,

FIG. 4 is a diagram showing the plot of dynamic spring rate against the frequency to be dampened.

### EXECUTION OF THE INVENTION

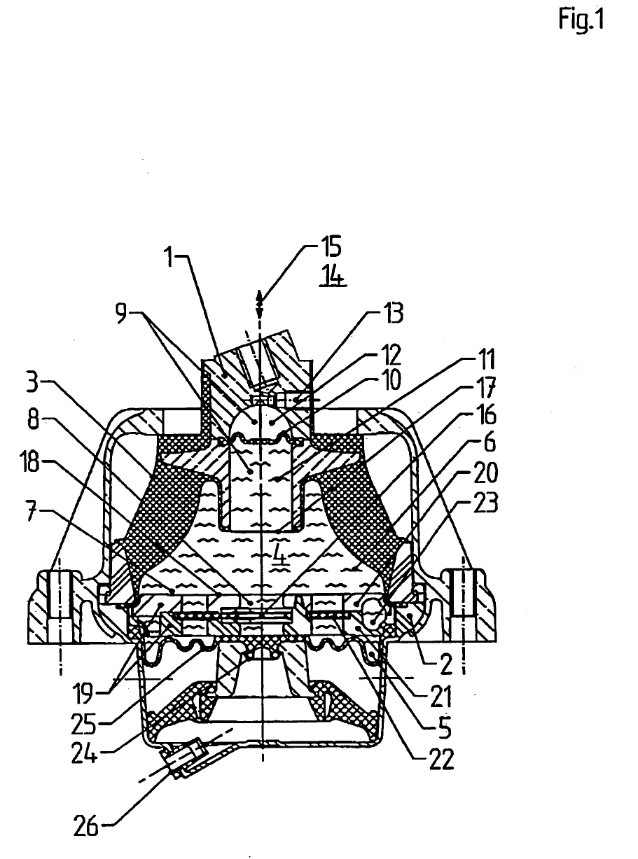

FIG. 1 shows an exemplary embodiment of the hydro-mount of the invention. The hydro-mount comprises a support bearing 1 and an end bearing 2 linked to each other by a bearing spring 3 made of elastomeric material. Inside the hydro-mount are located a working chamber 4 and a compensation chamber 5, both filled with damping fluid 6, the working chamber 4 and compensation chamber 5 on their mutually facing sides being limited by a common dividing wall 7. In the exemplary embodiment shown here, dividing wall 7 encloses not only the first damping channel 8 that links working chamber 4 with compensation chamber 5, if necessary, in flow-conveying manner, but it also encloses attenuation channel 23 intended for attenuating low-frequency, high-amplitude vibrations, and the second membrane 22 that is disposed between upper jet plate 20 and lower jet plate 21 in vibration-conveying manner, the two jet plates 20, 21 forming the jet cage 19. For the purpose of isolating high-frequency, low-amplitude vibrations, second membrane 22 can move back and forth in direction 15 of the vibrations introduced.

With first damping channel 8 is associated a second damping channel 9 that can be switched so as to function in parallel with damping channel 8. In the exemplary embodiment shown here, the first damping channel 8 is switchable and the second damping channel is not switchable, namely it is configured to be passive. The two damping channels 8,9 are always to be viewed as a damping channel system.

The following can be stated concerning the function of the hydro-mount. The bearing shown is adjusted so that at the lower boundary 18 the damping channel system brings about damping with the first damping channel 8 at a relatively low frequency 27, while at a higher frequency 28, the damping channel system acts with the second damping channel 9.

The second damping channel 9 is disposed in support bearing 1 and extends essentially in the direction of the vibrations introduced. First damping channel 8 and second damping channel 9 are disposed coaxially and near each other at an axial distance, so that for the damping of vibrations of the second and third as well as fourth and sixth order, when both damping channels 8, 9 are open, the liquid volumes present within damping channels 8,9 vibrate back and forth in phase with the vibrations of an idling supported internal combustion engine.

In the exemplary embodiment shown here, plug 24 whereby first damping channel 8 can be closed off is made integral with and of the same material as sealing membrane 25 that forms the boundary of compensation chamber 5 on the side facing away from dividing wall 7. Both plug 24 and sealing membrane 25 consist of an elastomeric material.

In the exemplary embodiment shown here, plug 24 is actuated by means of a pressure difference. The connection for the air line is indicated by 26. In the example shown, plug 24 is removed from first damping channel 8 by means of a negative pressure.

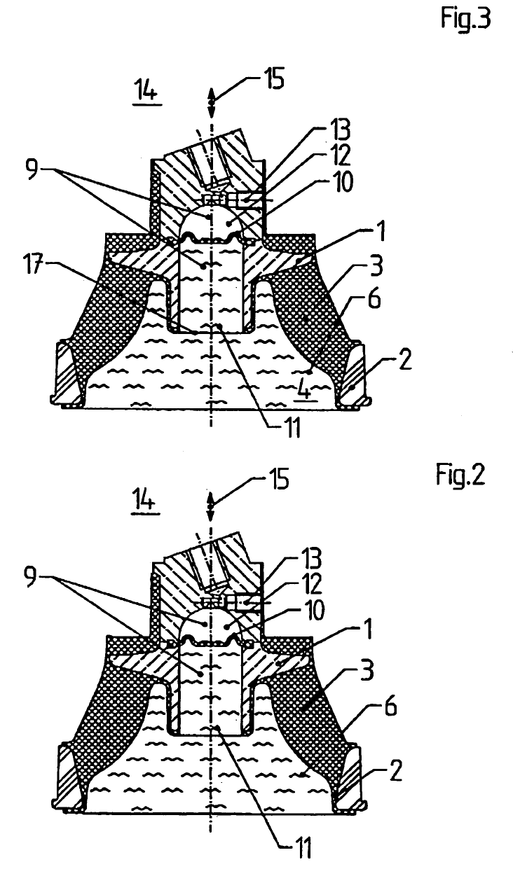

FIGS. 2 and 3 show the upper part of a hydro-mount. In FIGS. 2 and 3, the upper part shown comprises the support bearing 1 and the end bearing 2 linked to each other by bearing spring 3 made of an elastomeric material. Both the second damping channel 9 and the air vent 13 are disposed within support bearing 1 and thus, independently of the operating condition of the hydro-mount and always optimally positioned relative to each other.

First membrane 10 consisting of an elastically yielding material subdivides second damping channel 9 into two partial damping channels 11, 12. Membrane 10 is disposed within the second damping channel in tight-fitting manner. The first partial damping channel 11 axially facing working chamber 4 is filled with damping liquid 6 from working chamber 4, and the second partial damping channel 12 is filled with air, the second partial damping channel 12 possibly being connected to the atmosphere through air vent 13. First membrane 10 is in the form of a bellows.

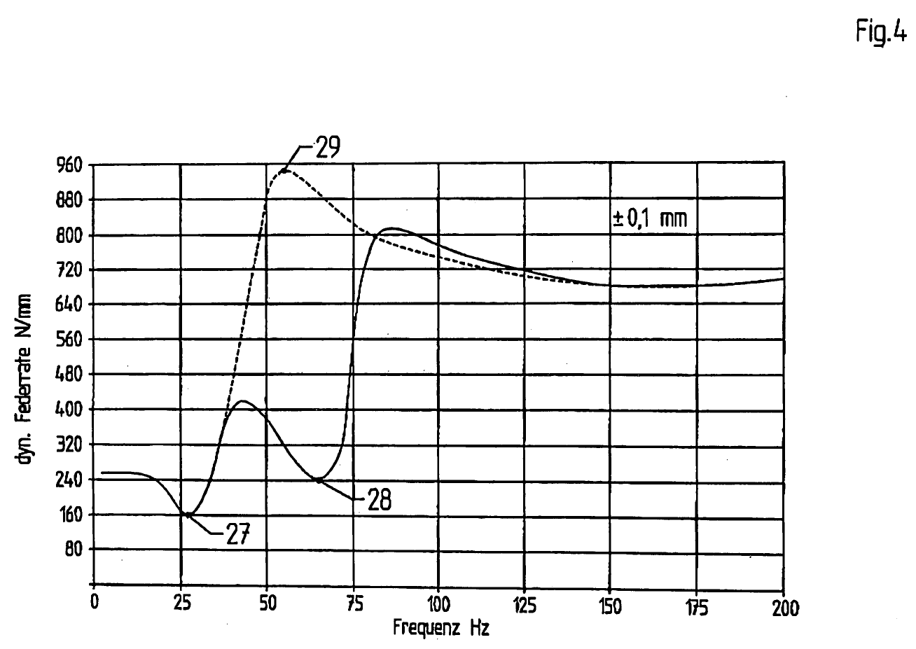

In FIG. 4, the functioning of the hydro-mount of the invention is represented by a plot of the dynamic spring rate against the frequency. Numeral 27 shows the first decrease in dynamic spring rate brought about by the functioning of the first damping channel 8. After point 27, with increasing frequency, the dynamic spring rate again increases. The parallel switching of second damping channel 9 causes the second decrease 28.

If the second damping channel 9 were not present, and the hydro-mount had only a first damping channel 8, the curve, starting from point 27, would run to peak 29 as shown by the broken line.

1. Hydro-mount comprising a support bearing and an end bearing linked to each other by a bearing spring made of an elastic material, said bearings enclosing a working chamber and a compensation chamber, both filled with a liquid, the working chamber and compensation chamber being separated from one another on their sides that face each other by a common dividing wall and being connected to each other in flow-conveying manner by a first damping channel, characterized in that with the first damping channel (8) is associated a second damping channel (9) that can be switched to function in parallel therewith.

2. Hydro-mount according to claim 1, characterized in that the first damping channel 8 and/or the second damping channel (9) are configured to be switchable.

3. Hydro-mount according to claim 1 or 2, characterized in that the first damping channel (8) is configured to be switchable and the second damping channel (9) is non-switchable, namely passive.

4. Hydro-mount according to claim 1, characterized in that the first damping channel (8) and the second damping channel (9) are both configured to be non-switchable, namely passive.

5. Hydro-mount according to one of claims 1 to 4, characterized in that the second damping channel (9) is subdivided by a first membrane (10), made of elastically yielding material, into two partial damping channels (11,12), that the partial damping channels (11,12) are tightly separated from one another by the membrane (10), that the first partial damping channel (11 ) axially facing the working chamber (4) is filled with damping liquid (6) and the second partial damping channel (12) is filled with air and that the second partial damping channel (12) is connected to the atmosphere (14) through a flow-conveying air vent (13).

6. Hydro-mount according to claim 5, characterized in that the first membrane (10) is in the form of a bellows.

7. Hydro-mount according to claim 5, characterized in that the air vent (13) is located in the support bearing (1).

8. Hydro-mount according to claim 5, characterized in that the second damping channel (9) is a closed air chamber.

9. Hydro-mount according to one of claims 1 to 8, characterized in that the second damping channel (9) is disposed in the support bearing (1) and extends essentially in the direction of the vibrations (15) introduced.

10. Hydro-mount according to one of claims 1 to 9, characterized in that the first damping channel (8) and the second damping channel (9) are disposed coaxially near each other and at an axial distance.

11. Hydro-mount according to one of claims 1 to 10, characterized in that the first damping channel (8) is disposed in the center (16) of the dividing wall (7).

12. Hydro-mount according to one of claims 1 to 11, characterized in that the first damping channel (8) and the second damping channel (9) are each disposed in the region of the axially mutually facing front boundaries (17,18) of the working chamber (4) and both open into the working chamber (4).

13. Hydro-mount according to one of claims 1 to 12, characterized in that the second damping channel (9) is open in the direction of the working chamber (4).

14. Hydro-mount according to one of claims 1 to 13, characterized in that the volume of the first damping channel (8) is greater than that of the second damping channel (9).

15. Hydro-mount according to one of claims 1 to 14, characterized in that the volume of the first damping channel (8) is smaller than that of the second damping channel (9).

16. Hydro-mount according to one of claims 1 to 15, characterized in that the dividing wall (7) is formed by a jet cage (19) comprising an upper jet plate (20) and a lower jet plate (21), a second elastic membrane (22) being disposed between the jet plates (20, 21) in vibration-conveying manner.

17. Hydro-mount according to claim 16, characterized in that the jet cage (19) encloses an attenuation channel (23) that connects the working chamber (4) and the compensation chamber (5) in flow-conveying manner.

18. Hydro-mount according to one of claims 1 to 17, characterized in that the first damping channel (8) can be closed off by a plug (24) made of a sealing material.

19. Hydro-mount according to one of claims 1 to 18, characterized in that the plug (24) is integral with and made of the same material as the sealing membrane (25) that provides a boundary for the compensation chamber (15) on the side facing away from the dividing wall (7).
